(19) United States
(12) Patent Application Publication
(10) Pub. No.: US 2006/0149802 A1
(43) Pub. Date: Jul. 6, 2006

(54) SCALING FILTER AND METHOD THEREOF

(76) Inventors: Shang-Chieh Wen, Tainan County (TW); Chen-Jen Huang, Tainan County (TW)

Correspondence Address: NORTH AMERICA INTELLECTUAL PROPERTY CORPORATION, P.O. BOX 506, MERRIFIELD, VA, 22116, US

(21) Appl. No.: 10/905,426

(22) Filed: Jan. 4, 2005

(51) Int. Cl. G06F 17/10

(52) U.S. Cl. 708/300

(57) ABSTRACT

A scaling filter includes: two line buffers for buffering a plurality of pixel values corresponding to a plurality of source pixels, respectively; (N+1) multiplexers coupled to the line buffers for multiplexing the pixel values to output (N+1) intermediate values, respectively, wherein N is an integer; N bit shifters coupled to N corresponding multiplexers out of the (N+1) multiplexers, respectively, each of the bit shifters bit-shifting a specific intermediate value outputted by a specific multiplexer to generate a shifted value; and a summation circuit coupled to a 1^{st} multiplexer out of the (N+1) multiplexers and the bit shifters for summing the intermediate value generated by the 1^{st} multiplexer and the shifted values generated by the bit shifters to generate a new pixel value.

### BACKGROUND OF INVENTION

1. Field of the Invention

The present invention relates to image scaling of a video display device such as a liquid crystal display (LCD) television or an LCD monitor, and more particularly, to a scaling filter and a method thereof.

2. Description of the Prior Art

A video display device such as a liquid crystal display (LCD) television or an LCD monitor usually includes a scaling filter, which is also referred to as a scalar for simplicity, for performing image scaling of video data to be displayed. The display dimension of the video display device can be very large, so a zoom (zoom in) operation on the video data is usually required. In addition, in most cases, certain useful functionality such as PIP/POP needs both the zoom operation mentioned above and a shrink operation. As a result, the scaling filter plays an important role in the video display device.

Please refer to FIG. 1 showing a block diagram of a scaling filter according to the prior art. This scaling filter, which is also known as a poly-phase finite impulse response (FIR) filter, includes a plurality of line buffers for buffering video data, a plurality of multipliers for multiplying the video data outputted from the line buffers by a plurality of coefficients, respectively, and a summation circuit for summing data outputted from all the multipliers. As long as many line buffers are utilized in the scaling filter shown in FIG. 1, the number of multipliers and multiplying operation thereof cannot be reduced. Therefore, implementing such a scaling filter introduces high material costs and heavy load of the multiplying operation.

### SUMMARY OF INVENTION

It is therefore an objective of the present invention to provide a scaling filter and a method thereof to solve the above-mentioned problem.

The present invention provides a scaling filter including: a plurality of line buffers for buffering a plurality of pixel values corresponding to a plurality of source pixels, respectively; (N+1) multiplexers coupled to the line buffers for multiplexing the pixel values to output (N+1) intermediate values, respectively, wherein N is an integer; N multipliers coupled to N corresponding multiplexers out of the (N+1) multiplexers, respectively, each of the multipliers multiplying a specific intermediate value outputted by a specific multiplexer by a specific factor to generate a multiplied value; and a summation circuit coupled to a 1^{st} multiplexer out of the (N+1) multiplexers and the N multipliers for summing the intermediate value generated by the 1^{st} multiplexer and the multiplied values generated by the multipliers to generate a new pixel value.

While the scaling filter mentioned above is disclosed, the present invention correspondingly provides a scaling filtering method including: buffering a plurality of pixel values corresponding to a plurality of source pixels, respectively; multiplexing the pixel values to output (N+1) intermediate values, respectively, wherein N is an integer; multiplying N corresponding intermediate values out of the (N+1) intermediate values by specific factors to generate N multiplied values, respectively; and summing a 1^{st} intermediate value out of the (N+1) intermediate values and the N multiplied values to generate a new pixel value.

According to an embodiment of the present invention, a scaling filter is further disclosed. The scaling filter includes: two line buffers for buffering a plurality of pixel values corresponding to a plurality of source pixels, respectively; (N+1) multiplexers coupled to the line buffers for multiplexing the pixel values to output (N+1) intermediate values, respectively, wherein N is an integer; N bit shifters coupled to N corresponding multiplexers out of the (N+1) multiplexers, respectively, each of the bit shifters bit-shifting a specific intermediate value outputted by a specific multiplexer to generate a shifted value; and a summation circuit coupled to a 1^{st} multiplexer out of the (N+1) multiplexers and the bit shifters for summing the intermediate value generated by the 1^{st} multiplexer and the shifted values generated by the bit shifters to generate a new pixel value.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of a scaling filter according to the prior art.

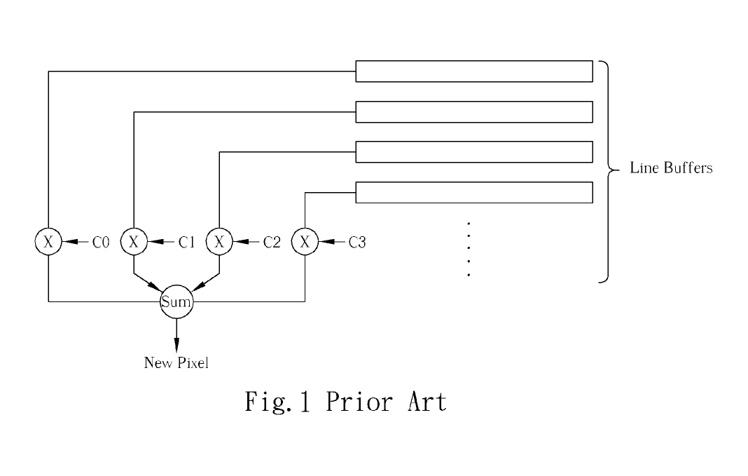

FIG. 2 is a block diagram of a scaling filter according to an embodiment of the present invention.

FIG. 3 is a diagram of characteristic curves of the scaling filter shown in FIG. 2 and a ploy-phase finite impulse response (FIR) filter.

### DETAILED DESCRIPTION

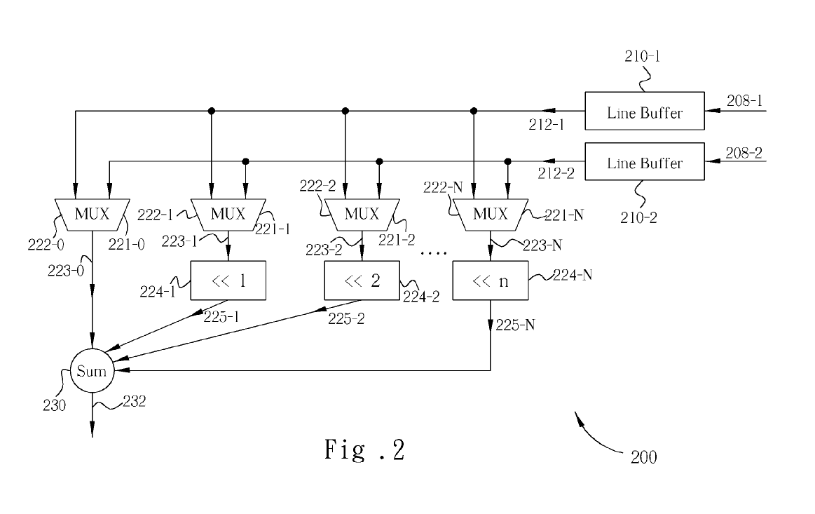

Please refer to FIG. 2 showing a block diagram of a scaling filter 200 according to an embodiment of the present invention. The scaling filter 200 can also be referred to as a scalar. In this embodiment, the scaling filter 200 includes a plurality of line buffers such as the line buffers 210-1 and 210-2, (N+1) multiplexers 222-0, 222-1, 222-2, . . . , 222-N, N multipliers, which are the bit shifters 224-1, 224-2, . . . , 224-N as shown in FIG. 2 according to this embodiment, and a summation circuit 230.

According to this embodiment, the scaling filter 200 is implemented utilizing only two line buffers 210-1 and 210-2. The line buffers 210-1 and 210-2 buffer a plurality of pixel values 208-1 and 208-2 corresponding to a plurality of source pixels, respectively, and output the pixel values 208-1 and 208-2 as output data 212-1 and 212-2 of the line buffers 210-1 and 210-2. Implementation of line buffers 210-1 and 210-2 and operation thereof are well known in the art and will not be described here.

As shown in FIG. 2, the (N+1) multiplexers 222-0, 222-1, 222-2, . . . , 222-N are coupled to the line buffers 210-1 and 210-2. The (N+1) multiplexers 222-0, 222-1, 222-2, . . . , 222-N multiplex the output data 212-1 and 212-2, which are the pixel values 208-1 and 208-2 as mentioned above, according to a plurality of bits 221-0, 221-1, 221-2, . . . , 221-N of a coefficient E to output (N+1) intermediate values 223-0, 223-1, 223-2, . . . , 223-N, respectively, where the bit 221-0 represents the least significant bit (LSB) of the coefficient E and the bit 221-N represents the most significant bit (MSB) of the coefficient E. The number of the bits 221-0, 221-1, 221-2, . . . , 221-N of the coefficient E utilized in this embodiment is equal to (N+1), where the number N mentioned above is a positive integer. Please note that the number N could be equal to one in an extreme case without considering the scaling quality of the scaling filter of the present invention.

According to the present invention, each of the N multipliers mentioned above multiplies a specific intermediate value outputted by a specific multiplexer by a specific factor to generate a multiplied value. In this embodiment, the N multipliers can be implemented utilizing the bit shifters 224-1, 224-2, . . . , 224-N as shown in FIG. 2 for simplicity. As shown in FIG. 2, the bit shifters 224-1, 224-2, . . . , 224-N are coupled to the multiplexers 222-1, 222-2, . . . , 222-N, respectively. Each bit shifter 224-K (where K=1, 2, . . . , or N here) bit-shifts the intermediate value 223-K outputted by the multiplexer 222-K to generate a shifted value 225-K. According to this embodiment, the K^{th} bit shifter 224-K bit-shifts K bits of the intermediate value 223-K to generate the shifted value 225-K. Please note that the bit shifter 224-K can be implemented by coupling output bits of the bit shifter 224-K to input bits of the bit shifter 224-K with a shift of K bits.

As shown in FIG. 2, the summation circuit 230 is coupled to the multiplexer 222-0 and the N multipliers, which are the bit shifters 224-1, 224-2, . . . , 224-N in this embodiment. The summation circuit 230 sums up the intermediate value 223-0 generated by the multiplexer 222-0 and the shifted values 225-1, 225-2, . . . , 225-N generated by the bit shifters 224-1, 224-2, . . . , 224-N, respectively, to generate a new pixel value 232.

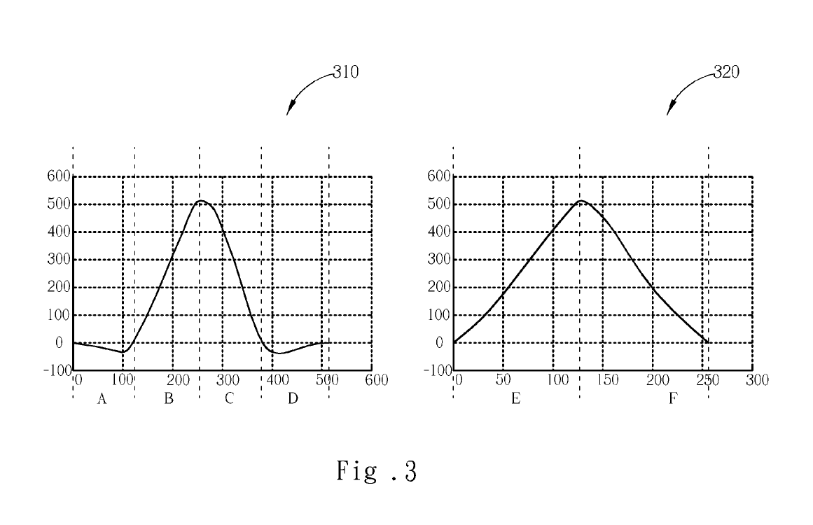

FIG. 3 is a diagram of a characteristic curve 310 of a 512 taps ploy-phase finite impulse response (FIR) filter (not shown) and a characteristic curve 320 of the scaling filter 200 shown in FIG. 2. The coefficients A, B, C, and D of the ploy-phase FIR filter mentioned above are listed under a corresponding portion of the characteristic curve 310 thereof as shown in FIG. 3, wherein each portion of the characteristic curve 310 corresponds to 128 taps, and the maximal scaling ratio is 128 times. Operation of the ploy-phase FIR filter and meanings of the characteristic curve 310 thereof are well known in the art and will not be described here. According to the present invention, the coefficient E mentioned above is complementary to another coefficient F of the scaling filter 200 due to the circuits shown in FIG. 2. That is, only one of the coefficients, E or F, needs to be inputted into the scaling filter 200. In a case having the coefficient E equal to (A+B) and the coefficient F equal to (C+D), the left half and the right half of the characteristic curve 320 correspond to 128 taps, respectively, and the characteristic curve 320 of the scaling filter 200 implies that the scaling filter 200 works utilizing a linear phase architecture.

In contrast to the prior art, the scaling filter 200 of the present invention and the method thereof may utilize only two line buffers so implementing the scaling filter 200 requires less material costs. In addition, the multipliers of the scaling filter 200 can be simply implemented utilizing bit shifters 224-1, 224-2, . . . , 224-N as mentioned above. Therefore, the operation of the scaling filter 200 of the present invention is simple and fast.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A scaling filter comprising:
a plurality of line buffers for buffering a plurality of pixel values corresponding to a plurality of source pixels, respectively;
(N+1) multiplexers coupled to the line buffers for multiplexing the pixel values to output (N+1) intermediate values, respectively, wherein N is an integer;
N multipliers coupled to N corresponding multiplexers out of the (N+1) multiplexers, respectively, each of the multipliers multiplying a specific intermediate value outputted by a specific multiplexer by a specific factor to generate a multiplied value; and
a summation circuit coupled to a 1^{st} multiplexer out of the (N+1) multiplexers and the N multipliers for summing the intermediate value generated by the 1^{st} multiplexer and the multiplied values generated by the multipliers to generate a new pixel value.

2. The scaling filter of claim 1, wherein the multipliers are bit shifters, and each of the bit shifters bit-shifts a specific intermediate value outputted by a specific multiplexer to generate a multiplied value.

3. The scaling filter of claim 2, wherein a K^{th} bit shifter out of the bit shifters bit-shifts K bits of an intermediate value.

4. The scaling filter of claim 1, wherein each of the multiplexers multiplexes a pixel value according to a value of a bit of a coefficient, and the number of bits of the coefficient is equal to (N+1).

5. The scaling filter of claim 1, wherein the scaling filter comprises only two line buffers.

6. A scaling filtering method comprising:
buffering a plurality of pixel values corresponding to a plurality of source pixels, respectively;
multiplexing the pixel values to output (N+1) intermediate values, respectively, wherein N is an integer;
multiplying N corresponding intermediate values out of the (N+1) intermediate values by specific factors to generate N multiplied values, respectively; and
summing a 1^{st} intermediate value out of the (N+1) intermediate values and the N multiplied values to generate a new pixel value.

7. The scaling filtering method of claim 6, wherein the multiplying step further comprises:
bit-shifting the N intermediate values to generate the N multiplied values, respectively.

8. The scaling filtering method of claim 7, wherein the bit-shifting step further comprises:
bit-shifting K bits of an intermediate value out of the N intermediate values to generate a K^{th} multiplied value out of the N multiplied values.

9. The scaling filtering method of claim 6, wherein the multiplexing step further comprises:
multiplexing a pixel value according to a value of a bit of a coefficient, wherein the number of bits of the coefficient is equal to (N+1).

10. The scaling filtering method of claim 6, wherein the scaling filtering method utilizes only two line buffers.

11. A scaling filter comprising:
two line buffers for buffering a plurality of pixel values corresponding to a plurality of source pixels, respectively;
(N+1) multiplexers coupled to the line buffers for multiplexing the pixel values to output (N+1) intermediate values, respectively, wherein N is an integer;
N bit shifters coupled to N corresponding multiplexers out of the (N+1) multiplexers, respectively, each of the bit shifters bit-shifting a specific intermediate value outputted by a specific multiplexer to generate a shifted value; and
a summation circuit coupled to a 1^{st} multiplexer out of the (N+1) multiplexers and the bit shifters for summing the intermediate value generated by the 1^{st} multiplexer and the shifted values generated by the bit shifters to generate a new pixel value.

12. The scaling filter of claim 11, wherein a K^{th} bit shifter out of the bit shifters bit-shifts K bits of an intermediate value.

13. The scaling filter of claim 11, wherein each of the multiplexers multiplexes a pixel value according to a value of a bit of a coefficient, and the number of bits of the coefficient is equal to (N+1).
